(19) United States
(12) Patent Application Publication
(10) Pub. No.: US 2026/0147082 A1
(43) Pub. Date: May 28, 2026

(54) ISAC SYSTEM INTEGRATING COMMUNICATION AND SENSING AND BEAMFORMING SYSTEM APPLYING THE SAME

(71) Applicant: Korea Electronics Technology Institute, Seongnam-si (KR)

(72) Inventors: Seok Yeon HONG, Suwon-si (KR); Se Hwan CHOI, Seongnam-si (KR); Seung Goo NAM, Suwon-si (KR)

(73) Assignee: Korea Electronics Technology Institute, Seongnam-si (KR)

(21) Appl. No.: 18/961,329

(22) Filed: Nov. 26, 2024

(30) Foreign Application Priority Data
Nov. 22, 2024 (KR) 10-2024-0167906

(51) Int. Cl. G01S 7/00; G01S 13/931; H01Q 1/32; H01Q 21/28

(52) U.S. Cl. CPC G01S 7/006; G01S 13/931; H01Q 21/28; H01Q 1/3233

(57) ABSTRACT

Provided are an ISAC system integrating communication and sensing and a beamforming system applying the same. An ISAC system according to an embodiment includes: a communication system configured to generate a transmission signal and to process a reception signal; a transmitter configured to convert the transmission signal generated by the communication system into a transmission signal of an RF band; a receiver configured to receive the reception signal of the communication system and a reflection signal of the transmission signal, and to convert the signals into a baseband; a radar system configured to use the transmission signal as a reference signal and to use the reflection signal as an echo signal of the reference signal; and a reference generator configured to generate a reference signal of a baseband from the transmission signal of the RF band and to apply the reference signal of the baseband to the radar system.

### CROSS-REFERENCE TO RELATED APPLICATION(S) AND CLAIM OF PRIORITY

This application is based on and claims priority under 35 U.S.C. § 119 to Korean Patent Application No. 10-2024-0167906, filed on Nov. 22, 2024, in the Korean Intellectual Property Office, the disclosure of which is herein incorporated by reference in its entirety.

### BACKGROUND

### Field

The disclosure relates to technological convergence of wireless communication and radio detection and ranging (radar), and more particularly, to an integrated sensing and communication (ISAC) system which performs a wireless communication function and a sensing function, simultaneously, by using the same frequency resources in a single piece of hardware.

### Description of Related Art

A wireless communication system and a radar system are allocated their respective unique frequency bands to operate, and hence, frequency spectrum may be used inefficiently. This may cause waste of resources, especially in an environment with high frequency congestion, and may extremely reduce spectrum efficiency, so that additional frequency allocation is required.

In addition, the wireless communication system and the radar system each require separate hardware, which increases overall system costs, and costs for independent design, manufacturing, and maintenance of each system may add to the economic burdens, and redundant hardware investments may degrade efficiency and result in waste of resources.

Furthermore, when the wireless communication system and the radar system use close frequency bands, radio wave interference may occur as shown in FIG. 1A, which gives rise to degradation of quality of communication signals and reduction of radar detection performance, and in turns, reduces system reliability.

In particular, the corresponding problem may be worse in a high-density environment as shown in FIG. 1B. That is, installing two independent systems in a limited space may degrade space efficiency, and may be an important issue, especially in a small platform (for example, a vehicle, a drone, and an aircraft), and may increase the design constraints of platforms and increase the weight and size of the whole systems, affecting the performance.

### SUMMARY

The disclosure has been developed in order to solve the above-described problems, and an object of the disclosure is to provide, as a solution for enhancing performance of ISAC, an ISAC system which generates a reference signal of a baseband from a transmission signal of a radio frequency (RF) band and uses the reference signal for a radar system and an ISAC beamforming system using the same.

To achieve the above-described object, an integrated sensing and communication (ISAC) system according to an embodiment of the disclosure may include: a communication system configured to generate a transmission signal and to process a reception signal; a transmitter configured to convert the transmission signal generated by the communication system into a transmission signal of an RF band; a receiver configured to receive the reception signal of the communication system and a reflection signal of the transmission signal, and to convert the signals into a baseband; a radar system configured to use the transmission signal as a reference signal and to use the reflection signal as an echo signal of the reference signal; and a reference generator configured to generate a reference signal of a baseband from the transmission signal of the RF band and to apply the reference signal of the baseband to the radar system.

The reference generator may include: a coupler configured to split a part of the transmission signal of the RF band; a first mixer configured to generate an analogue transmission signal of an IF band by mixing the transmission signal of the RF band split by the coupler with an LO signal which is used to up-convert a transmission signal into an RF band; and a first ADC configured to generate a reference signal by converting the analogue transmission signal of the IF band into a digital transmission signal of a baseband, and to apply the reference signal to the radar system.

A split ratio of the transmission signal at the coupler may be less than or equal to a defined ratio.

The transmitter may include: a DAC configured to convert a digital transmission signal of a baseband generated by the communication system into an analogue transmission signal of an IF band; a second mixer configured to generate a transmission signal of an RF band by mixing the analogue transmission signal of the IF band with an LO signal; and a first amplifier configured to amplify the transmission signal of the RF band, and the receiver may include: a second amplifier configured to amplify a reception signal of an RF band; a third mixer configured to generate an analogue reception signal of an IF band by mixing the reception signal of the RF band with an LO signal; and a second ADC configured to convert the analogue reception signal of the IF band into a digital reception signal of a baseband and to apply the digital reception signal of the baseband to the communication system and the radar system.

The ISAC system according to the disclosure may further include: a circulator configured to connect an output end of the first amplifier to an antenna in a transmission mode, and to connect an input end of the second amplifier to the antenna in a reception mode; and a switch configured to connect the input end of the second amplifier and the circulator in the reception mode, and to disconnect the input end of the second amplifier and the circulator in the transmission mode.

The switch may ground a branch from the circulator to the input end of the second amplifier in the transmission mode.

The ISAC system according to the disclosure may further include a first beamforming unit configured to perform analogue beamforming at a rear end of the circulator.

The ISAC system according to the disclosure may further include a second beamforming unit configured to perform digital beamforming at a rear end of the communication system.

The first beamforming unit and the second beamforming unit may control beamforming based on a result of detecting a target by the radar system.

According to another aspect of the disclosure, there is provided an ISAC method including: generating, by a communication system, a transmission signal; converting, by a transmitter, the transmission signal into a transmission signal of an RF band; generating, by a reference generator, a reference signal of a baseband from the transmission signal of the RF band, and applying the reference signal of the baseband to a radar system; receiving, by a receiver, a reception signal of the communication system and a reflection signal of the transmission signal, and converting the signals into a baseband; and detecting, by the radar system, a target by using the transmission signal as a reference signal and using the reflection signal as an echo signal of the reference signal.

According to still another aspect of the disclosure, there is provided a radar system including: a transmitter configured to convert a transmission signal into a transmission signal of an RF band; a receiver configured to receive a reflection signal of the transmission signal, and to convert the signal into a baseband; a radar configured to use the transmission signal as a reference signal and to use the reflection signal as an echo signal of the reference signal; and a reference generator configured to generate a reference signal of a baseband from the transmission signal of the RF band and to apply the reference signal of the baseband to the radar system.

As described above, according to embodiments of the disclosure, a reference signal of a baseband may be generated from a transmission signal of an RF band, and a reference signal that best matches a reference signal on which an echo signal is based may be reconstructed and may be allowed to be used for a radar system, so that target detection performance of the radar system may be enhanced.

According to embodiments of the disclosure, the ISAC system may be provided with a hybrid beamforming function, so that not only wireless communication performance but also radar detection performance may be enhanced.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a view provided to explain a problem in sharing the spectrum through cohabitation;

FIG. 1B is a view provided to explain a problem in sharing the spectrum through cooperation;

FIG. 2 is a view illustrating spectrum sharing through codesign;

FIG. 3 is a view illustrating an ISAC system according to an embodiment of the disclosure;

FIG. 4 is a view illustrating a detailed configuration of the ISAC system shown in FIG. 3;

FIG. 5 is a view illustrating an ISAC beamforming system according to another embodiment of the disclosure;

FIG. 6 is a view illustrating a correlation process using sampling of a coupler;

FIG. 7 is a view illustrating a result of acquiring a correlated echo signal; and

FIG. 8A is a view illustrating examples of applying ISAC.

FIG. 8B is a view illustrating examples of applying ISAC.

FIG. 8C is a view illustrating examples of applying ISAC.

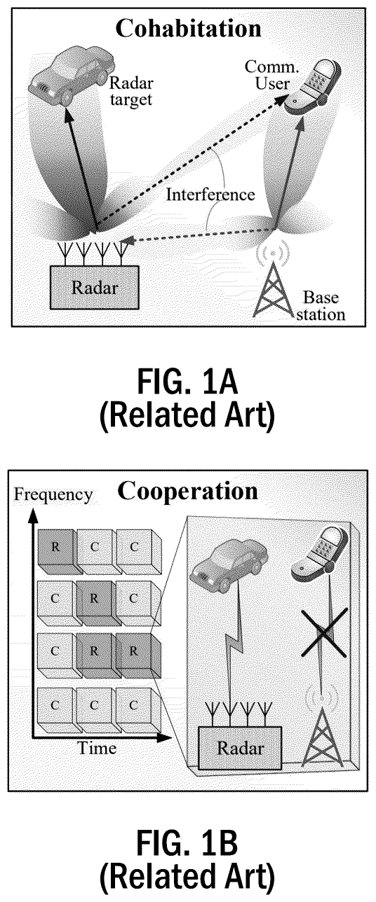

### DETAILED DESCRIPTION

Hereinafter, the disclosure will be described in more detail with reference to the accompanying drawings.

Integrated sensing and communication (ISAC) has emerged as a technology for solving a spectrum congestion problem, by enhancing spectrum efficiency by integrating a wireless communication function and a radar function into a single platform and allowing the two functions to share the same frequency spectrum and hardware components, and by enabling dual-function use of the same spectrum band.

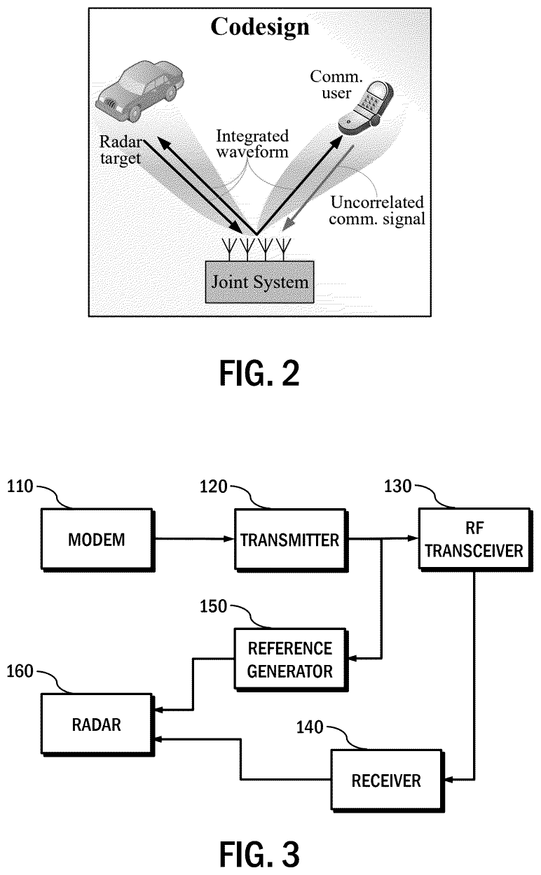

An ISAC system may use shared hardware components including an antenna, a transmitter, a receiver, and a signal processor through codesign as shown in FIG. 2, and may reuse an existing communication infrastructure for a radar function, so that the overall system costs and complexity may be minimized.

The same waveform is used for both communication and radar functions, and one signal transmits data and simultaneously performs radar detection and distance measurement. For example, the communication waveform defined in IEEE 802.11p and IEEE 802.11ad standards may be modified for the purpose of radar by using signal characteristics embedded therein.

The method of designing the integrated waveform and signal processing strategy through codesign and managing communication and radar functions in one hardware platform in common is the most innovative and premising approach.

An embodiment of the disclosure proposes an ISAC system to which codesign is applied and a beamforming system applying the same. The disclosure proposes an efficient hardware structure which is applicable in performing a wireless communication function and a radar function by using the same frequency resources in a single piece of hardware, and a technology for applying the same to a beamforming system.

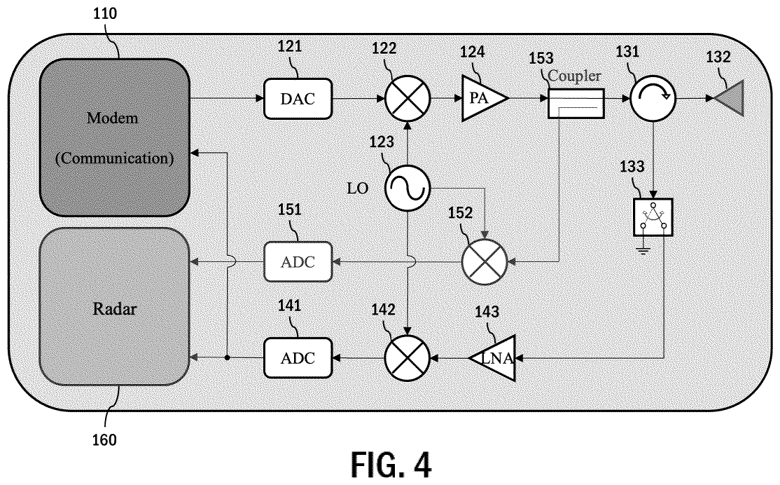

FIG. 3 is a view illustrating a configuration of an ISAC system according to an embodiment of the disclosure. The ISAC system according to an embodiment of the disclosure may be integrated hardware which performs a sensing function and a communication function, simultaneously, and may include a modem 110, a transmitter 120, an RF transceiver 130, a receiver 140, a reference generator 150, and radar 160 as shown in FIG. 3.

The modem 110 may be a wireless communication system which generates a transmission signal through signal modulation and processes a reception signal through signal demodulation. The transmitter 120 may convert a transmission signal of a baseband generated by the modem 110 into a transmission signal of an RF band to be transmitted through a wireless channel.

The RF transceiver 130 may transmit the transmission signal of the RF band outputted from the transmitter 120 to the wireless channel, and may forward a reception signal of an RF band received through the wireless channel to the receiver 140.

The reception signal may include a wireless communication signal that should be processed by the modem 110, and a reflection signal of a transmission signal that should be processed by the radar 160. Accordingly, the receiver 140 may convert the reception signal of the RF band forwarded through the RF transceiver 130 into a reception signal of a baseband, and may forward the reception signal of the baseband to both the modem 110 and the radar 160.

The reference generator 150 may generate a reference signal of a baseband from the transmission signal of the RF band outputted from the transmitter 120, and may apply the reference signal of the baseband to the radar 160. In the ISAC system according to an embodiment of the disclosure, the reference generator 150 may generate the reference signal required for cross-correlation with an echo signal of the reference signal since the radar 160 does not generate the reference signal but uses the transmission signal generated by the modem 110 for wireless communication as the reference signal.

The radar 160 may use the transmission signal generated by the modem 110 as the reference signal, and may use the reflection signal of the transmission signal, which is received through the RF transceiver 130 and processed by the receiver 140, as the eco signal of the reference signal, and may measure the distance and location of a target by obtaining a cross-correlation between the two signals.

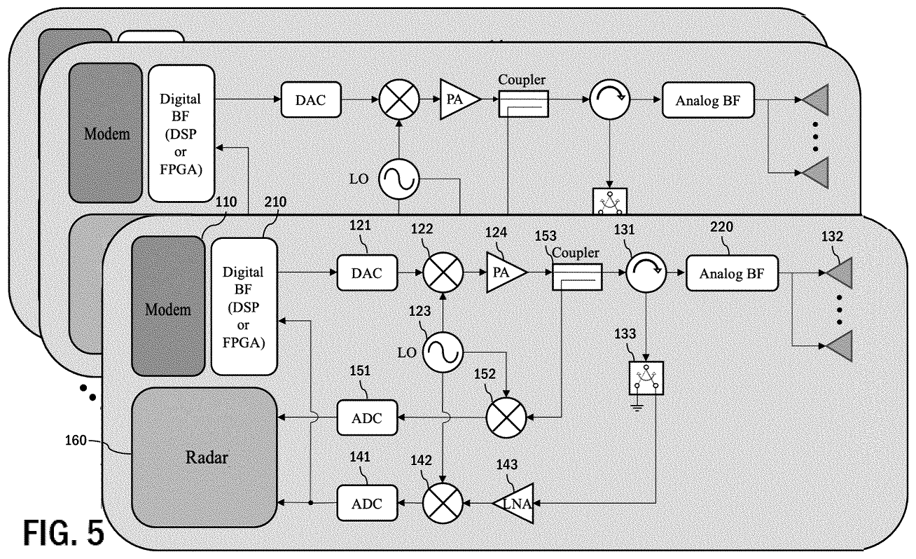

Hereinafter, detailed configurations of the transmitter 120, the RF transceiver 130, the receiver 140, and the reference generator 150 will be described with reference to FIG. 4. FIG. 4 is a view illustrating a detailed configuration of the ISAC system shown in FIG. 3.

A digital to analog converter (DAC) 121, a mixer 122, a local oscillator (LO) 123, and a power amplifier (PA) 124 among the components shown in FIG. 4 may constitute the transmitter 120.

The DAC 121 may convert a digital transmission signal of a baseband generated by the modem 110 into an analogue transmission signal of an intermediate frequency (IF) band. The mixer 122 may generate a transmission signal of an RF band by mixing the analogue transmission signal of the IF band outputted from the DAC 121 with an LO signal generated by and outputted from the LO 123 and performing frequency up-conversion. The PA 124 may amplify the transmission signal of the RF band outputted from the mixer 122.

A circulator 131, an antenna 132, and a switch 133 among the components shown in FIG. 4 may constitute the RF transceiver 130.

In a transmission mode, the circulator 131 may connect the output end of the PA 124, which constitutes the transmitter 120, to the antenna 132 (through a coupler 153) to transmit the transmission signal of the RF band outputted from the PA 124 through the antenna 132.

In a reception mode, the circulator 131 may connect an input end of a low noise amplifier (LNA) 143 constituting the receiver 140 to the antenna 132 (through the switch 133) to transmit a reception signal of an RF band received through the antenna 132 to the receiver 140.

The switch 133 may be a switching means for disconnecting a path between the circulator 131 and the receiver 140 in the transmission mode, and for connecting the path between the circulator 131 and the receiver 140 only in the reception mode.

It may be possible to isolate a transmission signal and a reception signal by the circulator 131, but in an embodiment of the disclosure, the switch 133 may be added to guarantee high isolation. In particular, in the transmission mode, the switch 133 may ground a branch from the circulator 131 to the receiver 140, so that a power-amplified transmission signal may be prevented from entering the receiver 140 more safely.

An analog to digital converter (ADC) 141, a mixer 142, a low noise amplifier (LNA) 143 among the components shown in FIG. 4 may constitute the receiver 140.

The LNA 143 may low-noise amplify a reception signal of an RF band transmitted through the RF transceiver 130, and the mixer 142 may generate an analogue reception signal of an IF band by mixing the reception signal of the RF band outputted from the LNA 143 with an LO signal generated by and outputted from the LO 123 and performing frequency down-conversion. The ADC 141 may convert the analogue reception signal of the IF band generated into a digital reception signal of a baseband, and may apply the digital reception signal of the baseband to the modem 110 and the radar 160.

An ADC 151, a mixer 152, and the coupler 153 among the components shown in FIG. 4 may constitute the reference generator 150. As described above, the radar 160 may use a wireless communication signal of the modem 110 as a reference signal, rather than generating a reference signal by itself, and hence, may require the reference generator 150.

The coupler 153 may split a part of the transmission signal of the RF band outputted from the PA 124 of the transmitter 120, and may transmit the signal to the mixer 152. That is, the coupler 153 may sample a part of the transmission signal of the RF band. To enhance efficiency of the transmission signal, it is desirable to set a split ratio at the coupler 153 to be very small, for example, to 1/10 or less.

The mixer 152 may generate an analogue transmission signal of an IF band by mixing the transmission signal of the RF band split by the coupler 153 with the LO signal generated by and outputted from the LO 123, and performing frequency down-conversion. The ADC 151 may convert the analogue transmission signal of the IF band generated into a digital transmission signal of a baseband, and may apply the digital transmission signal of the baseband to the radar 160. The applied transmission signal may be used at the radar 160 as a reference signal.

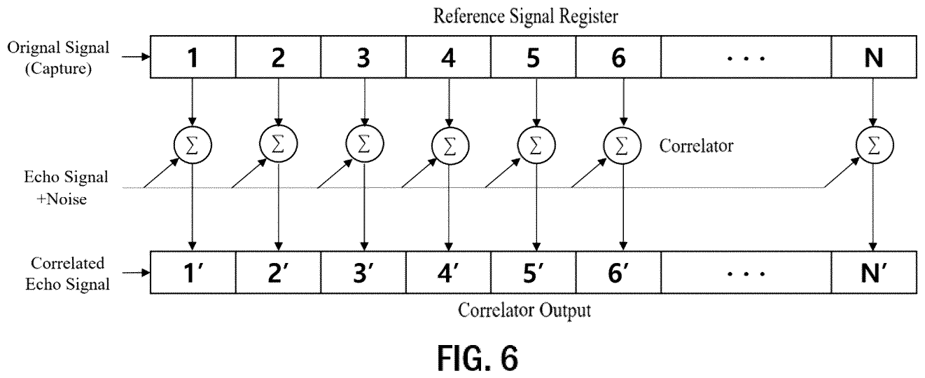

FIG. 5 is a view illustrating a configuration of an ISAC beamforming system according to another embodiment of the disclosure. The ISAC beamforming system according to an embodiment of the disclosure is the system of FIG. 5 to which a hybrid beamforming function is added. This is to support beamforming not only in the modem 110 but also in the radar 160.

Specifically, the ISAC beamforming system according to an embodiment may include a plurality of ISAC systems, each of which further includes a digital beamforming unit 210 and an analogue beamforming unit 220 in addition to the components of the ISAC system proposed in FIG. 5.

The analogue beamforming unit 220 may be a beamforming integrated circuit (IC) which is provided at the rear end of the circulator 131, and may adjust an amplitude and a phase with an analogue beamforming function. The digital beamforming unit 210 may be provided at the rear end of the modem 110 to adjust an amplitude and a phase with a digital beamforming function, and may be implemented by a digital signal processor (DSP) or a field programmable gate array (FPGA).

The digital beamforming unit 210 and the analogue beamforming unit 220 may be controlled with reference to a result of detecting a target by the radar 160. That is, beamforming may be controlled to be oriented toward a target or not to be oriented toward a target.

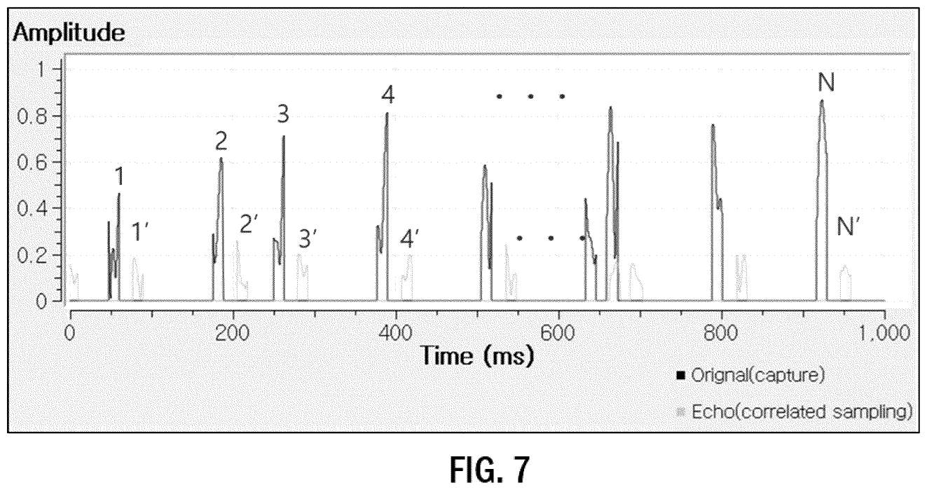

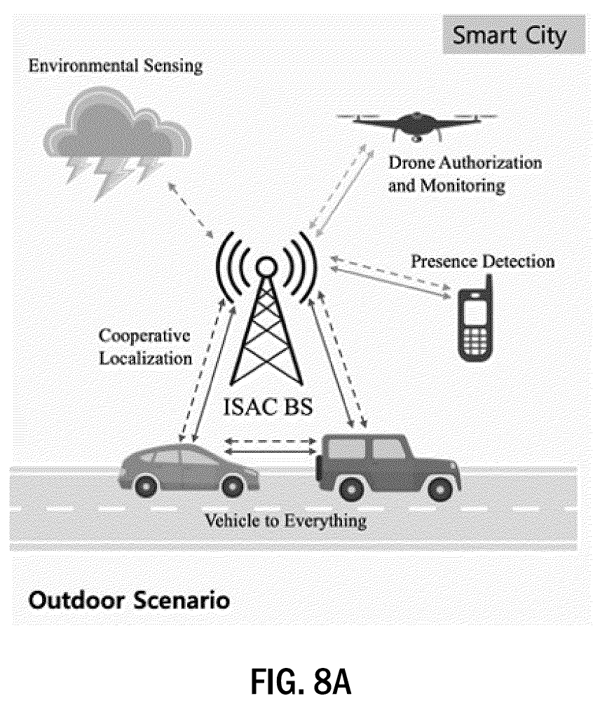

FIG. 6 is a view illustrating a correlation process which uses sampling by the coupler 153. The coupler 153 may perform a function of sampling a part of a transmission signal, and the sampled data may be inputted to a reference signal register. The data inputted to the register may sample a part of a reception signal that matches the transmission signal through the correlation process with a received echo signal. As a result, the correlated echo signal of FIG. 7 may be obtained, and a distance to an object may be calculated based on the delay time of corresponding data.

Up to now, the ISAC system integrating communication and sensing and the beamforming system applying the same have been described in detail with reference to preferred embodiments.

In the above-described embodiments, a reference signal of a baseband is generated from a transmission signal of an RF band, and the reference signal that best matches a reference signal causing an echo signal is allowed to be used for a radar system, so that target detection performance of the radar system may be enhanced. The technical configuration of the disclosure is applicable to a radar system other than the ISAC system.

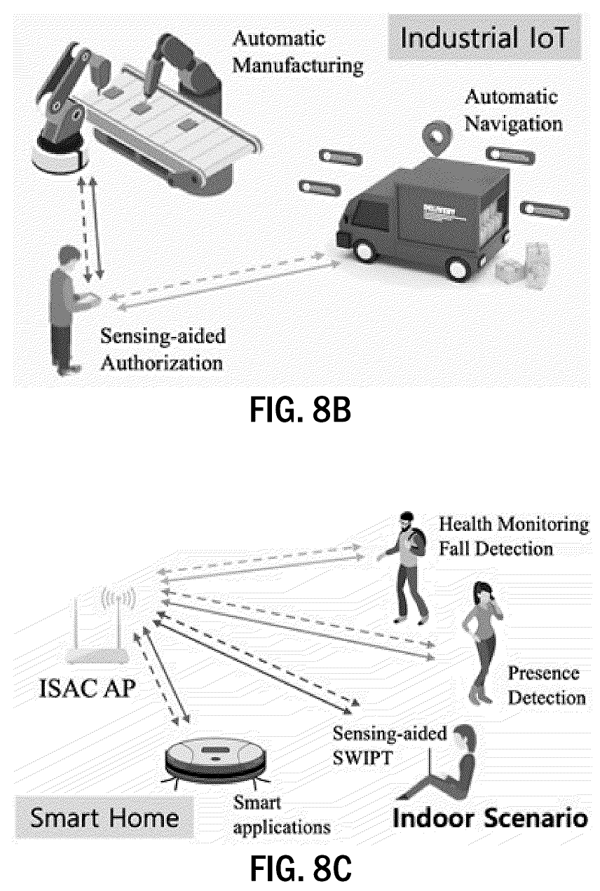

FIGS. 8A to 8C show examples of applying the ISAC. The ISAC provides high data transfer rates and precise sensing functions, accelerating the development of next-generation mobile communications and facilitating the emergence of new communication services. Accordingly, monitoring and management of city infrastructures may be more efficient and accurate with real-time data transmission and precise sensing technologies, and the integration of communication and sensing technologies may contribute to improving the safety and efficiency of autonomous vehicles, and smooth communication and sensing between IoT devices may enable the creation of new services and business models.

Furthermore, the ISAC technology may reduce energy consumption of systems by efficiently managing frequency resources and energy, and may contribute to the development of eco-friendly technologies. The utilization of the ISAC technology in various industrial fields can enhance productivity and efficiency, and the emergence of new technologies and application will result in the technological advancement across industries.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An integrated sensing and communication (ISAC) system comprising:
a communication system configured to generate a transmission signal and to process a reception signal;
a transmitter configured to convert the transmission signal generated by the communication system into a transmission signal of an RF band;
a receiver configured to receive the reception signal of the communication system and a reflection signal of the transmission signal, and to convert the signals into a baseband;
a radar system configured to use the transmission signal as a reference signal and to use the reflection signal as an echo signal of the reference signal; and
a reference generator configured to generate a reference signal of a baseband from the transmission signal of the RF band and to apply the reference signal of the baseband to the radar system.

2. The ISAC system of claim 1, wherein the reference generator comprises:
a coupler configured to split a part of the transmission signal of the RF band;
a first mixer configured to generate an analogue transmission signal of an IF band by mixing the transmission signal of the RF band split by the coupler with an LO signal which is used to up-convert a transmission signal into an RF band; and
a first ADC configured to generate a reference signal by converting the analogue transmission signal of the IF band into a digital transmission signal of a baseband, and to apply the reference signal to the radar system.

3. The ISAC system of claim 2, wherein a split ratio of the transmission signal at the coupler is less than or equal to a defined ratio.

4. The ISAC system of claim 2, wherein the transmitter comprises:
a DAC configured to convert a digital transmission signal of a baseband generated by the communication system into an analogue transmission signal of an IF band;
a second mixer configured to generate a transmission signal of an RF band by mixing the analogue transmission signal of the IF band with an LO signal; and
a first amplifier configured to amplify the transmission signal of the RF band, and
wherein the receiver comprises:
a second amplifier configured to amplify a reception signal of an RF band;
a third mixer configured to generate an analogue reception signal of an IF band by mixing the reception signal of the RF band with an LO signal; and
a second ADC configured to convert the analogue reception signal of the IF band into a digital reception signal of a baseband and to apply the digital reception signal of the baseband to the communication system and the radar system.

5. The ISAC system of claim 4, further comprising:
a circulator configured to connect an output end of the first amplifier to an antenna in a transmission mode, and to connect an input end of the second amplifier to the antenna in a reception mode; and
a switch configured to connect the input end of the second amplifier and the circulator in the reception mode, and to disconnect the input end of the second amplifier and the circulator in the transmission mode.

6. The ISAC system of claim 5, wherein the switch is configured to ground a branch from the circulator to the input end of the second amplifier in the transmission mode.

7. The ISAC system of claim 5, further comprising a first beamforming unit configured to perform analogue beamforming at a rear end of the circulator.

8. The ISAC system of claim 7, further comprising a second beamforming unit configured to perform digital beamforming at a rear end of the communication system.

9. The ISAC system of claim 8, wherein the first beamforming unit and the second beamforming unit are configured to control beamforming based on a result of detecting a target by the radar system.

10. An ISAC method comprising:
generating, by a communication system, a transmission signal;
converting, by a transmitter, the transmission signal into a transmission signal of an RF band;
generating, by a reference generator, a reference signal of a baseband from the transmission signal of the RF band, and applying the reference signal of the baseband to a radar system;
receiving, by a receiver, a reception signal of the communication system and a reflection signal of the transmission signal, and converting the signals into a baseband; and
detecting, by the radar system, a target by using the transmission signal as a reference signal and using the reflection signal as an echo signal of the reference signal.

11. A radar system comprising:
a transmitter configured to convert a transmission signal into a transmission signal of an RF band;
a receiver configured to receive a reflection signal of the transmission signal, and to convert the signal into a baseband;
a radar configured to use the transmission signal as a reference signal and to use the reflection signal as an echo signal of the reference signal; and
a reference generator configured to generate a reference signal of a baseband from the transmission signal of the RF band and to apply the reference signal of the baseband to the radar system.
